(19) United States
(12) Patent Application Publication
(10) Pub. No.: US 2017/0313281 A1
(43) Pub. Date: Nov. 2, 2017

(54) DEFROST DUCT WITH ACOUSTIC MATERIAL INSERTS

(71) Applicant: GM GLOBAL TECHNOLOGY OPERATIONS LLC, Detroit, MI (US)

(72) Inventors: Martin P. Van Fossan, Lake Orion, MI (US); Javier Rojo Garcia, Neza (MX); Edmund M. Mizgalski, Sterling Heights, MI (US); Jeffrey S. True, Waterford, MI (US); Jorge Francisco Guzman De Leon Lopez, Jiutepec (MX)

(73) Assignee: GM GLOBAL TECHNOLOGY OPERATIONS LLC, Detroit, MI (US)

(21) Appl. No.: 15/141,211

(22) Filed: Apr. 28, 2016

(51) Int. Cl. B60S 1/02; B60S 1/54

(52) U.S. Cl. CPC B60S 1/023; B60S 1/54

(57) ABSTRACT

A defrost duct assembly for a vehicle includes a housing having a wall that defines an air passage. The air passage extends between an inlet and an outlet of the housing. The wall includes an opening into the air passage. A noise attenuation panel is attached to the housing, and covers the opening in the housing. The noise attenuation panel is an acoustic material that is operable to attenuate noise from within the passage of the housing, while maintaining sufficient air flow to adequately defrost a front windshield of the vehicle. The housing may include multiple outlets and multiple openings covered by one or more noise attenuation panels. The noise attenuation panel is preformed to mate with the housing, and minimize disturbance to the flow of air within the passage.

### TECHNICAL FIELD

The disclosure generally relates to a defrost duct assembly for a vehicle.

### BACKGROUND

Many vehicles include a Heating Ventilation Air Conditioning (HVAC) system for delivering a flow of either heated or cooled air into a passenger compartment. The HVAC system includes a fan module that is operable to move the flow of air through a system of ducts, to draw air from the passenger compartment and/or move air into the passenger compartment. Often, the HVAC system includes a defrost duct assembly that is specifically dedicated to directing at least a portion of the flow of air onto a windshield of the vehicle in order to at least partially defrost the windshield within a desired time requirement. It is important to maintain a minimum air flow through the defrost duct assembly in order to defrost the windshield within the desired time requirement. However, the significant airflow through the defrost duct assembly, which is required to defrost the windshield within the desired time requirement, may generate noise within the passenger compartment.

### SUMMARY

A defrost duct assembly for a vehicle is provided. The defrost duct assembly includes a housing having a wall. The wall defines an air passage that extends between an inlet and an outlet. The wall includes an opening into the air passage. A noise attenuation panel is attached to the housing, and covers the opening in the housing. The noise attenuation panel is an acoustic material that is operable to attenuate noise from within the passage of the housing.

Accordingly, the noise attenuation panel of the defrost duct assembly attenuates or lessens noise from within the air passage of the housing, in order to reduce noise in a passenger compartment of the vehicle. The noise attenuation panel reduces the noise level within the air passage, while maintaining the required air flow needed to defrost a front windshield of the vehicle.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic perspective view of a defrost duct assembly from a front side.

FIG. 2 is a schematic perspective view of the defrost duct assembly from a back side.

FIG. 3 is a schematic perspective exploded view of a front half of the defrost duct assembly.

FIG. 4 is a schematic perspective exploded view of a back half of the defrost duct assembly.

FIG. 5 is a schematic perspective exploded view of the defrost duct assembly, showing the front half and the back half prior to attachment together.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Referring to the Figures, wherein like numerals indicate like parts throughout the several views, a defrost duct assembly is generally shown at 20. The defrost duct assembly 20 may be used in a vehicle for directing a flow of air onto a windshield of the vehicle. The vehicle may include, but is not limited to, a car, a truck, a plane, a bus, a train, a tractor, a motorcycle, or some other type of vehicle. The defrost duct assembly 20 is part of a Heating Venting Air Conditioning (HVAC) system of the vehicle. The HVAC system includes a system of ducts, of which the defrost duct assembly 20 is one. The HVAC system includes, but is not limited to, a fan or blower motor that is operable to move air through the system of ducts. The HVAC system may draw or recycle air from an interior compartment of the vehicle and direct it back into the interior compartment of the vehicle, or may draw air from an exterior of the vehicle, and direct it into the interior compartment of the vehicle. The HVAC system may include subsystems that are operable to heat or cool the flow of air as requested by a controller, as is known in the art.

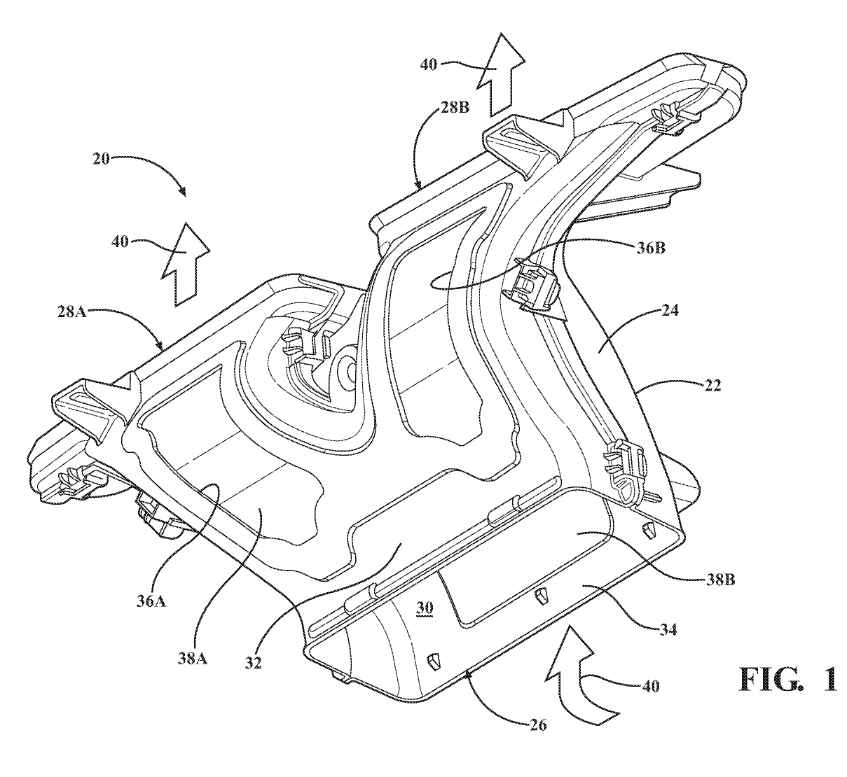

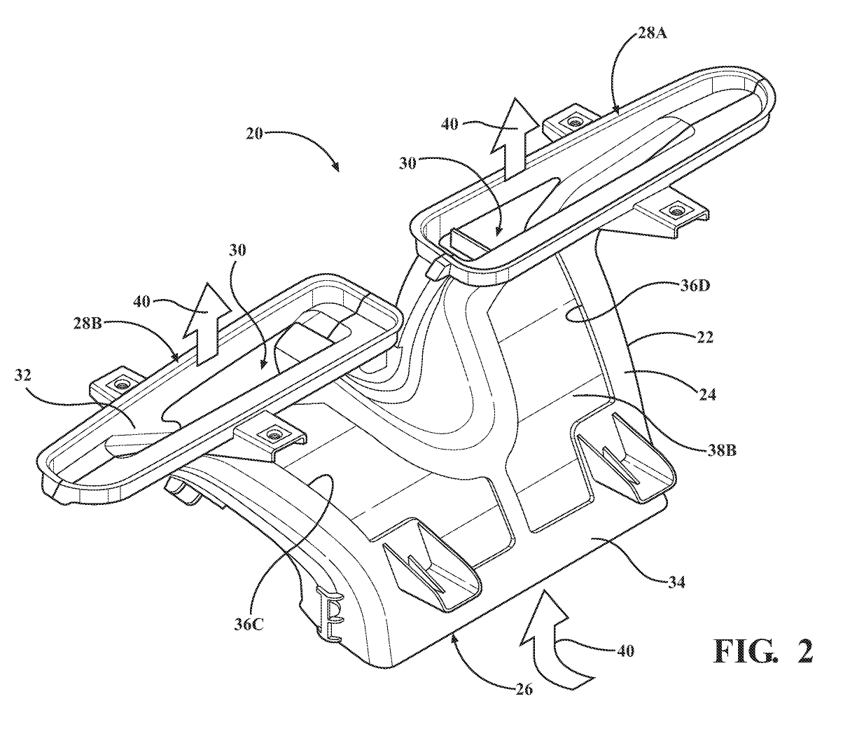

As noted above, the defrost duct assembly 20 receives the flow of air from the blower motor, and is positioned within a dash of the vehicle to specifically direct the flow of air onto the front windshield of the vehicle, in order to defrost the front windshield. The flow of air is generally indicated by arrows 40 in FIGS. 1 and 2. It is desirable for the HVAC system to be capable of defrosting at least a pre-defined percentage of the windshield within a desired time requirement. In order to accomplish this, the defrost duct assembly 20 must be capable conducting a certain quantity or volume of air therethrough and onto the windshield. The amount of air will depend upon the size of the defrost duct assembly 20, the temperature of the flow of air, the size of the windshield, and the percentage of the windshield to be cleared, i.e., defrosted. However, it should be appreciated that maximizing airflow through the defrost duct assembly 20, e.g., reducing losses in the flow of air through the defrost duct assembly 20, reduces the amount or volume of air that the blower motor must move, and/or power required to move the flow of air.

Referring to FIGS. 1 and 2, the defrost duct assembly 20 includes a housing 22. The housing 22 includes a wall 24 that defines an air passage 30. The air passage 30 extends between an inlet 26 and at least one outlet 28 of the housing 22. As shown in the Figures and as described herein, the exemplary embodiment of the defrost duct assembly 20 includes a single inlet 26 for receiving the flow of air from the blower motor, and two outlets 28, i.e., a left outlet 28A and a right outlet 28B. For countries that drive on the right side of the road, such as the United States, the left outlet 28A may be considered a driver's side outlet positioned for directing a portion of the flow of air onto a driver's side of the windshield, and the right outlet 28B may be considered a passenger's side outlet positioned for directing a portion of the flow of air onto a passenger's side of the windshield. The outlet, including both the left outlet 28A and the right outlet 28B, is referred to generally herein by the reference number 28. The left outlet is referred to specifically herein and shown in the Figures at 28A. The right outlet is referred to specifically herein and shown in the Figures at 28B.

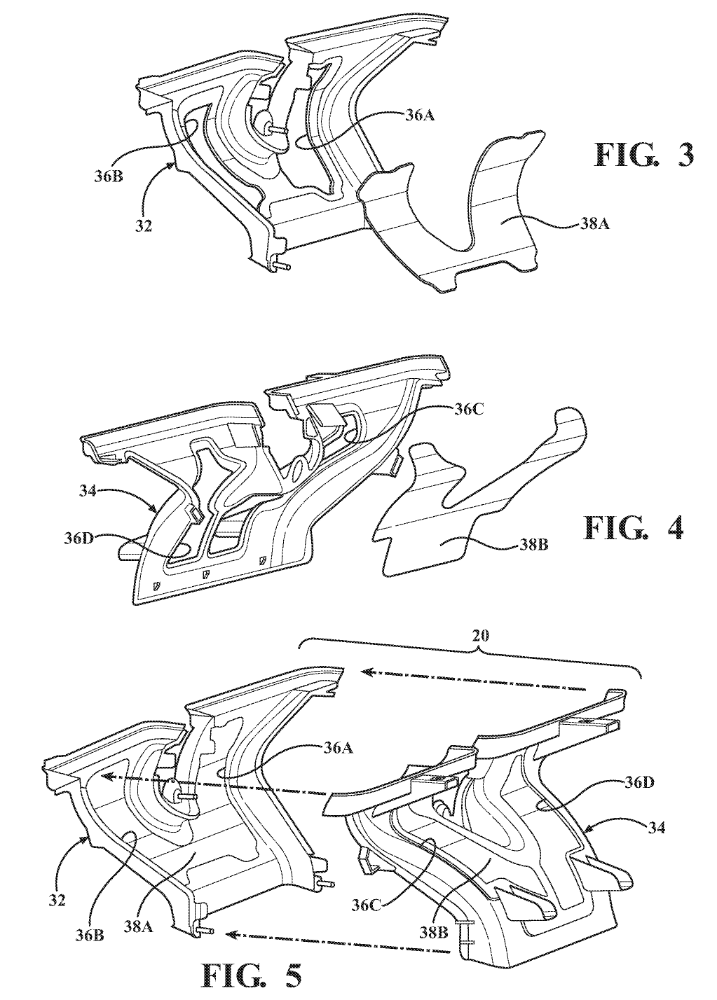

In the exemplary embodiment shown and described herein, the wall 24 of the housing 22 includes a front half 32, and a back half 34, which are attached together to define the air passage 30 therebetween. The front half 32 and the back half 34 are shown attached together in FIGS. 1 and 2. The front half 32 is shown separately in FIG. 3, and the back half 34 is shown separately in FIG. 4. Both the front half 32 and the back half 34 of the wall 24 extend between the inlet 26 and the outlet 28. Accordingly, it should be appreciated that the front half 32 of the wall 24 partially defines the inlet 26, the left outlet 28A, the right outlet 28B, and the back half 34 of the wall 24 partially defines the inlet 26, the left outlet 28A, and the right outlet 28B. The front half 32 and the back half 34 of the wall 24 may be attached together by any suitable manner. For example, the front half 32 and the back half 34 may include one or more interlocking clips, latches, hooks, etc., that are capable of attaching and securing the front half 32 and the back half 34 together. Alternatively, the front half 32 and the back half 34 of the wall 24 may be attached together by welding, adhesion, mechanical fasteners, or some other similar attachment mechanism. Additionally, it should be appreciated that the wall 24 may be formed as a single unit, in which case the front half 32 and the back half 34 would be integrally formed together.

The wall 24 includes at least one opening 36A, 36B, 36C, 36D into the air passage 30. The opening 36A, 36B, 36C, 36D completely extends through the wall 24, to connect an exterior of the housing 22 to the interior of the housing 22, i.e., the air passage 30, in fluid communication. As shown in the Figures and described herein, the opening includes at least one front opening in the front half 32 of the housing 22, and at least one back opening in the back half 34 of the housing 22. More specifically, referring to FIG. 3, the front opening includes a left front opening 36A into the air passage 30 and a right front opening 36B into the air passage 30. The left front opening 36A generally extends between the inlet 26 and the left outlet 28A, and the right front opening 36B generally extends between the inlet 26 and the right outlet 28B. Similarly, referring to FIG. 4, the back opening includes a left back opening 36C into the air passage 30, and a right back opening 36D into the air passage 30. The left back opening 36C generally extends between the inlet 26 and the left outlet 28A, and the right back opening 36D generally extends between the inlet 26 and the right outlet 28B. The opening is referred to generally herein by the reference number 36, and includes the left front opening 36A, the right front opening 36B, the left back opening 36C, and the right back opening 36D. The left front opening is referred to specifically herein and shown in the Figures at 36A. The right front opening is referred to specifically herein and shown in the Figures at 36B. The left back opening is referred to specifically herein and shown in the Figures at 36C. The right back opening is referred to specifically herein and shown in the Figures at 36D.

The defrost duct assembly 20 includes at least one noise attenuation panel 38. The noise attenuation panel 38 is attached to the housing 22, and covers the opening 36 in the housing 22. The noise attenuation panel 38 is an acoustic material that is operable to attenuate noise from within the passage of the housing 22. Preferably, the acoustic material is a porous material. For example, the acoustic material may be a polypropylene material. However, it should be appreciated that the material from which the noise attenuation panel 38 is manufactured may differ from the exemplary polypropylene material. The acoustic material may include any noise abatement material that is capable of providing an air flow dissipation rate that is less than a pre-defined maximum dissipation rate, and that is capable of being formed into and holding a specific three dimensional shape. As used herein, the term “air flow dissipation rate” should be interpreted as the rate at which air passes from within the air passage 30, through the acoustic material, to an exterior of the housing 22. For example, the air flow dissipation rate may be measured in terms of a percentage or volume of the air moved through the air passage 30 that passes through the acoustic material. The pre-defined maximum dissipation rate depends on the specific shape, size, and configuration of the vehicle, as well as the defrosting requirements for that vehicle. However, an exemplary range for the pre-defined maximum dissipation rate may include, but is not limited, a maximum of 3-10% air flow loss, or a rate of between 70 liters/second or 95 liters/second.

As noted above, the acoustic material should be capable of being formed into and holding a specific three dimensional shape. The acoustic material may include a rigidity or stiffness that is sufficient to maintain a formed shape of the noise attenuation panel 38 in response to air pressure within the passage being less than a pre-defined maximum air pressure. The pre-defined maximum air pressure may include any air pressure that the defrost duct is designed to accommodate for the specific application. Accordingly, by manufacturing the noise attenuation panel 38 from an acoustic material that includes a rigidity sufficient to maintain the formed shape of the noise attenuation panel 38, the noise attenuation panel 38 will not significantly, bend, flex, wave, etc., in response to the flow of air at or below the pre-defined maximum air pressure.

The acoustic material is shaped and formed to define the noise attenuation panel 38. Accordingly, the noise attenuation panel 38 includes a formed shape that is formed to mate with the housing 22 around a periphery of the opening 36 in the housing 22. The formed shape may include any shape, and may include a curved surface that defines a curve in at least one dimension. The formed shape of the noise attenuation panel 38 is generally defined by the shape of the wall 24 of the housing 22 to which the noise attenuation panel 38 is attached. It should be appreciated that the formed shape may include a surface that curves in more than one dimension. For example, the noise attenuation panel 38 may be formed to define a formed shape that changes in three dimensions, e.g., an X dimension, a Y dimension, and a Z dimension. However, it should be appreciated that the noise attenuation panel 38 does not have to include a three dimensional shape, and may alternatively be formed to include a flat, planar shape.

As noted above, the defrost duct assembly 20 includes one or more noise attenuation panels 38 that are attached to the housing 22 and cover the opening 36. In the exemplary embodiment shown and described herein, the noise attenuation panel 38 includes a first noise attenuation panel 38A, best shown in FIG. 3, and a second noise attenuation panel 38B, best shown in FIG. 4. The noise attenuation panel is referred to generally by the reference number 38, and includes both the first noise attenuation panel 38A and the second noise attenuation panel 38B. The first noise attenuation panel is specifically referred to herein and shown in the Figures at 38A, and the second noise attenuation panel is specifically referred to herein and shown in the Figures at 38B. As shown in the exemplary embodiment, the first noise attenuation panel 38A is attached to the front half 32 of the wall 24, and covers both the left front opening 36A and the right front opening 36B. The second noise attenuation panel 38B is attached to the back half 34 of the wall 24, and covers both the left back opening 36C and the right back opening 36D.

The noise attenuation panel 38 may be attached to the housing 22 in any suitable manner. For example, the noise attenuation panel 38 may be attached to the wall 24 of the housing 22 using any suitable welding process, adhesion or bonding process, fastening process, etc. For example, an exemplary process for attaching the noise attenuation panel 38 to the wall 24 of the housing 22 includes a hot plate welding process, which is known to those skilled in the art. The specific process used to attach the noise attenuation panel 38 to the wall 24 of the housing 22 may depend upon the materials used to manufacture the housing 22, as well as the acoustic material used to manufacture the noise attenuation panel 38.

Because the defrost duct assembly 20 must provide a certain amount of air flow to the windshield to at least partially defrost a desired percentage of the windshield within the desired time requirement, maximizing air flow through the defrost duct assembly 20 has been a priority. However, air flow through the defrost duct generates noise that is communicated to a passenger compartment of the vehicle, which is undesirable. Because acoustic materials allow a certain amount of air to pass through the material in order to attenuate noise, acoustic materials have not previously been used in defrost ducts, due to the conflict between the air flow requirement for defrosting the windshield, and the loss of airflow that acoustic materials inherently present. This is because the required flow of air for defrosting the windshield was prioritized over noise abatement. However, by using an acoustic material with a dissipation rate that is less than the pre-defined maximum dissipation rate, and by forming the noise attenuation panel 38 to contour to the wall 24 of the housing 22, the losses and disturbances in the flow of air through the air passage 30 of the housing 22 are minimized, thereby maintaining the required amount of air flow to the windshield while still providing some noise abatement for the passenger compartment of the vehicle. For example, having the noise attenuation panels 38 contoured to match the contours of the wall 24 of the housing 22, minimizes turbulence in the flow of air through the air passage 30 that otherwise accompanies the use of acoustic materials in ducts.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A defrost duct assembly for a vehicle, the defrost duct assembly comprising:
a housing including a wall defining an air passage extending between an inlet and at least one outlet;
wherein the wall includes an opening into the air passage; and
a noise attenuation panel attached to the housing and covering the opening in the housing, wherein the noise attenuation panel is an acoustic material operable to attenuate noise from within the passage of the housing.

2. The defrost duct assembly set forth in claim 1, wherein the noise attenuation panel includes a formed shape that is formed to mate with the housing around a periphery of the opening in the housing.

3. The defrost duct assembly set forth in claim 2, wherein the formed shape of the noise attenuation panel includes a curved surface defining a curve in at least one dimension.

4. The defrost duct assembly set forth in claim 2, wherein the acoustic material includes a rigidity sufficient to maintain the formed shape of the noise attenuation panel when an air pressure within the passage is less than a pre-defined maximum air pressure.

5. The defrost duct assembly set forth in claim 1, wherein the wall of the housing includes a front half and a back half attached together to define the passage therebetween.

6. The defrost duct assembly set forth in claim 5, wherein the outlet includes a left outlet and a right outlet.

7. The defrost duct assembly set forth in claim 6, wherein the opening includes at least one front opening in the front half of the housing.

8. The defrost duct assembly set forth in claim 7, wherein the at least one front opening includes a left front opening generally extending between the inlet and the left outlet, and a right front opening generally extending between the inlet and the right outlet.

9. The defrost duct assembly set forth in claim 8, wherein the noise attenuation panel includes a first noise attenuation panel covering both the left front opening and the right front opening.

10. The defrost duct assembly set forth in claim 6, wherein the opening includes at least one back opening in the back half of the housing.

11. The defrost duct assembly set forth in claim 10, wherein the at least one back opening includes a left back opening generally extending between the inlet and the left outlet, and a right back opening generally extending between the inlet and the right outlet.

12. The defrost duct assembly set forth in claim 11, wherein the noise attenuation pane includes a second noise attenuation panel covering both the left back opening and the right back opening.

13. The defrost duct assembly set forth in claim 1, wherein the acoustic material provides an air flow dissipation rate that is less than a pre-defined maximum dissipation rate.

14. The defrost duct assembly set forth in claim 1, wherein the acoustic material is a porous material.

15. A defrost duct assembly for directing a flow of air onto a windshield of a vehicle, the defrost duct assembly comprising:
a housing having an inlet for receiving the flow of air, a left outlet for discharging a portion of the flow of air onto a left side of the windshield, and a right outlet for discharging another portion of the flow of air onto a right side of the windshield;
wherein the housing includes a wall having a front half and a back half attached together to define an air passage therebetween, extending between the inlet and the left outlet and between the inlet and the right outlet for directing the flow of air between the inlet and the left outlet and the right outlet;
wherein the front half of the wall includes a left front opening into the air passage, and a right front opening into the air passage;
wherein the back half of the wall includes a left back opening into the air passage, and a right back opening into the air passage;
at least one noise attenuation panel attached to the housing, and covering at least one of the left front opening, the right front opening, the left back opening, and the right back opening, wherein the at least one noise attenuation panel is an acoustic material operable to attenuate noise from within the passage of the housing, while maintaining an air flow dissipation rate that is less than a pre-defined maximum value.

16. The defrost duct assembly set forth in claim 15, wherein the noise attenuation panel includes a formed shape that is formed to mate with the housing around a periphery of the opening in the housing.

17. The defrost duct assembly set forth in claim 16, wherein the formed shape of the noise attenuation panel includes a curved surface defining a curve in at least one dimension.

18. The defrost duct assembly set forth in claim 16, wherein the acoustic material includes a rigidity sufficient to maintain the formed shape of the noise attenuation panel when an air pressure within the passage is less than a pre-defined maximum air pressure.

19. The defrost duct assembly set forth in claim 15, wherein the acoustic material is a polypropylene material.

20. The defrost duct assembly set forth in claim 15, wherein the at least one noise attenuation panel includes a first noise attenuation panel attached to the front half of the wall and covering both the left front opening and the right front opening in the housing, and a second noise attenuation panel attached to the back half of the wall and covering both the left back opening and the right back opening in the housing.
